(19) United States
(12) Patent Application Publication
(10) Pub. No.: US 2020/0150593 A1
(43) Pub. Date: May 14, 2020

(54) TIMEPIECE MOVEMENT

(71) Applicants: GFPI S.A., La Chaux-de-Fonds (CH); COMPLITIME SA, La Chaux-de-Fonds (CH)

(72) Inventors: Stephen FORSEY, Les Brenets (CH); François TRIFONI, Le Locle (CH); Florian CORNEILLE, Mathay (FR); David BERNARD, Saint-Aubin (CH)

(73) Assignees: GFPI S.A., La Chaux-de-Fonds (CH); COMPLITIME SA, La Chaux-de-Fonds (CH)

(21) Appl. No.: 16/609,527

(22) PCT Filed: May 3, 2018
(86) PCT No.: PCT/EP2018/061289

§ 371 Date: Oct. 30, 2019

(30) Foreign Application Priority Data
May 5, 2017 (EP) 17169650.3

(51) Int. Cl. G04B 19/02; G04B 17/28

(52) U.S. Cl. CPC G04B 19/02; G04B 17/285

(57) ABSTRACT

Clock movement comprising: —at least one drive member; —four regulating systems, each one being kinematically connected to said drive member via a drivetrain designed to transmit the energy of the drive member to said regulating systems, in which said drivetrain comprises: —a first differential gear having one input kinematically connected to the drive member and having two outputs; —a second and a third differential gear each one having an input kinematically connected to a respective output of the first differential gear, and each one having two outputs, each of these latter outputs being kinematically connected to a respective regulating system; said movement further comprising a device for displaying the hours and minutes and which is designed to be driven by the first differential gear. According to the invention, said movement comprises at least one device for displaying the seconds, this device being branched off from said drivetrain and designed to take power off this drivetrain, said device for displaying the seconds comprising a second-indicating member rotating as one with a runner which is in direct or indirect mesh with a runner that said drivetrain comprises, said runner being situated upstream of at least one of said second and third differential gears.

### TECHNICAL FIELD

The present invention relates to the field of watchmaking. It concerns, more specifically, a timepiece movement comprising a plurality of regulating systems.

### STATE OF THE ART

Document EP 1 706 796 describes a timepiece movement comprising two tourbillons connected to a common drive organ by means of a differential gear. This differential gear permits the tourbillon cages to rotate independently of one another and serves to average their rates. The wheels of the going train thus rotate at angular speeds in function of the average of the rate of the two tourbillons, which serves to improve the accuracy of the running of the movement.

However, the dial train is arranged conventionally in relation to the going train, which imposes limitations on the freedom of the watchmaker to optimize the transmission of torque and to choose the speeds of rotation of the wheels, the tourbillons and all the gear trains concerned.

Document WO 2013/104982 discloses a timepiece comprising four regulating organs, driven by a drive organ by means of a kinematic drive network comprising a plurality of differential gears. However, neither this arrangement, nor the “Quatuor” timepiece from Roger Dubuis which implements it, comprises means of indicating the seconds. The obvious solution for indicating the seconds would be to integrate an appropriate display organ in the drive network, notably rotationally integrated with one of the four seconds wheels that the mechanism comprises. However, this solution would be very limited with regard to the possibilities for the spatial arrangement of the organ for displaying the seconds in the movement. In fact, there are only four positions which present themselves and which do not require substantial modification with regard to the construction of the movement.

The aim of the invention is consequently to propose a timepiece movement in which the aforementioned disadvantages are at least partially overcome.

### DISCLOSURE OF THE INVENTION

More precisely, the invention relates to a timepiece movement comprising at least one drive organ such as a mainspring situated in a barrel, as well as four regulating systems of any type, each one being kinematically linked to said drive organ by means of a kinematic drive network. This kinematic network is arranged to transmit energy from the drive organ to each of the regulating systems, in such a way that it is possible to trace a kinematic link transmitting energy between the drive organ and each of the regulating systems.

More precisely, the kinematic drive network comprises:
a first differential gear having one input kinematically linked to the drive organ and having two outputs;
a second and a third differential gear, each having one input kinematically linked to a respective output of the first differential gear and each having two outputs. Each of these latter outputs is kinematically linked to a respective regulating system.

The movement further comprises a device for displaying the hours and the minutes arranged to be driven by the first differential gear, either directly, or indirectly.

According to the invention, the movement further comprises at least one device for displaying the seconds, this device being branched off from said kinematic network and taking power from the latter, said device for displaying the seconds comprising a seconds-indicating organ that is rotationally integrated with a wheel which is in direct or indirect meshed engagement with a wheel comprised by said kinematic drive network. This wheel is situated upstream of at least one of said second and third differential gears.

Since the seconds display is not part of the kinematic network, the designer benefits from a freedom of construction which allows him to position the display in the movement as he sees fit, and independently of the device for displaying the hours and minutes. Furthermore, and contrary to a so-called conventional direct “small seconds” display, the positioning of the seconds display is likewise decoupled from the position of the regulating systems.

Advantageously, the device for displaying the hours and the minutes is arranged to be driven directly by an element of the first differential gear, for example by driving a dial train by means of the wheel serving as the input of the first differential gear. Alternatively, an organ for displaying minutes may be rotationally integrated with such a wheel, the hours display organ being driven in a conventional manner via a reduction gear mechanism.

Advantageously, the device for displaying the seconds comprises a seconds-indicating organ arranged to be driven by an element of the first differential gear by means of a multiplicative gear train. Alternatively, the seconds-indicating organ is arranged to be driven by an element of a barrel housing a mainspring serving as said drive organ, by means of a multiplicative gear train. As a further alternative, the seconds-indicating organ is arranged to be driven by an element situated between a barrel and said input of said first differential gear by means of a multiplicative gear train.

Surprisingly, the use of four regulating systems permits the use of a drive organ which is sufficiently powerful to drive a multiplier wheel in this way, without the risk of overloading, and, as a result, without damaging the regulating organs. In fact, a mainspring which is sufficiently powerful to drive four oscillators may be used without applying an excess of torque to the regulating systems, since the torque supplied is divided by four by the differential gears of the kinematic network. It almost goes without saying that the use of a multiplicative gear train in this way is normally totally excluded from consideration altogether because of the increase in the effective inertia of the components thereby generated, as well as the corresponding increase in the friction that is created. These two increases contribute to a significant increase in the torque required for driving the organ for displaying the seconds. It is for this reason that the displays are always driven from the going train in a ratio of 1:1 or by a demultiplicative gear mechanism, which limits the torque required for driving; the use of a multiplicative gear mechanism to drive a particular display organ is not known to the applicant, in particular in the case of a watch. The arrangement mentioned above thus overcomes this technical bias.

Advantageously, at least one of said differential gears comprises a constant force system, which limits variations in the torque transmitted to the regulating systems and as such serves to improve the isochronism of the movement.

### BRIEF DESCRIPTION OF THE DRAWINGS

Other details of the invention will emerge more clearly on reading the following description, which is given with reference to the drawings attached hereto, in which:

FIG. 1 is a schematic representation of a first embodiment of a movement according to the invention; and

FIG. 2 is a schematic representation of a second embodiment of a movement according to the invention.

### EMBODIMENT OF THE INVENTION

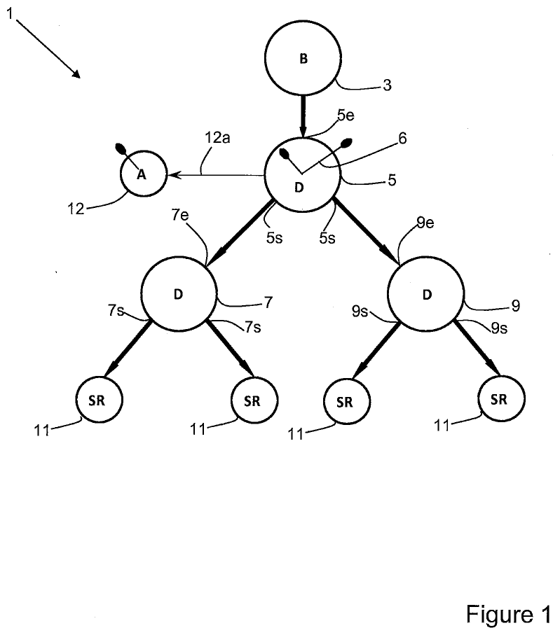

FIG. 1 depicts schematically an embodiment of a timepiece movement 1 according to the invention.

The movement 1 comprises a drive organ 3, which, for example, may be one or a plurality of mainsprings situated in one or a plurality of barrels in series and/or in parallel.

The drive organ 3 is kinematically linked to an input 5e of a first differential gear 5 formed from appropriate wheels. This differential gear 5 may be of any type, for example of spherical type, of flat type or of any other configuration. The differential gear 5 as defined in the present invention comprises an input 5e and two outputs 5s. The mechanical connection between the input 5e and the outputs 5s may be implemented in any conventional manner, for example by means of one or a plurality of planetary gears, by one or a plurality of elastic elements or by any mechanism permitting an equivalent function to these latter. It may likewise comprise at least one differential with a constant force device as described in document EP 2 548 084, which is incorporated integrally here by reference. This or these constant force devices may be present at the level of the one or more differentials, but likewise between the one or more differentials and the one or more regulating systems.

The first differential gear 5 drives a device for displaying the hours and the minutes 6 directly or indirectly, from one of the elements by which it is constituted. The device for displaying the hours and the minutes 6 may comprise organs for displaying the hours and minutes, for example one or a plurality of hands, disks, rotating scales, bands, or similar.

In order to drive the device for displaying the hours and the minutes 6, one of the wheels forming the differential gear, for example the wheel serving as the input 5e, may drive a dial train or, alternatively, one of the wheels may be arranged to rotate at the rate of one rotation per hour, the display organ for the minutes (a hand, disk, strip or similar) being rotationally integrated with one of the latter, and the display organ for the hours being driven by means of a reduction gear in a conventional manner.

The two outputs 5s of the differential gear 5 each supply energy to the respective input 7e, 9e of a second differential gear 7 and respectively a third differential gear 9, formed from appropriate wheels. These second and third differential gears each also comprise two outputs 7s, 9s respectively, each of these outputs 7s, 9s being kinematically linked directly or indirectly to a respective regulating system 11. The same comments in relation to the type of differential gear made in relation to the first differential gear 5 are likewise applicable to the second and third differential gears 7, 9.

The network of differential gears 5, 7, 9, and of any intermediate wheels that are not represented here, forms a kinematic drive network which serves to transmit and to distribute energy and torque from the drive organ 3 to each of the four regulating systems 11 in such a way that it is possible to trace a kinematic chain transmitting driving force from the drive organ 3 to each regulating system 11.

The regulating systems 11 may be of any type, and may comprise, for example, Swiss or English lever escapements, mono-axial, bi-axial or tri-axial tourbillons, detent escapements, cylinder escapements or escapements of any other type that are known to the man skilled in the art. Each regulating system 11 may be identical to or different from the others, and may oscillate at the same frequency as, or at a different frequency from the others. In the case of tourbillons, the speed of rotation of the individual cages may likewise be identical to or different from that of the other cages. This makes it possible to work out an average for the rate of a plurality of types of regulating systems, and, thereby, to improve the isochronism of the movement.

In the embodiment illustrated in FIG. 1, an element of the first differential gear 5 drives a device 12 for displaying the seconds indirectly by means of a multiplicative gear train, the latter being represented schematically by the arrow 12a. For example, said device 12 for displaying the seconds may comprise an organ for displaying the seconds, such as a hand, a disk or similar rotationally integrated with a corresponding wheel which is part of the multiplicative gear train 12a. The seconds display organ may make one revolution in 30 seconds, one, two, three, four or five minutes, or similar. Alternatively, the device 12 for displaying the seconds may comprise a wheel which is in direct meshed engagement with a wheel of the kinematic network, in which case the latter rotates at an appropriate angular speed. In any case, the calculation of the angular speeds and the gear ratios for each desired configuration is within the capability of a man skilled in the art.

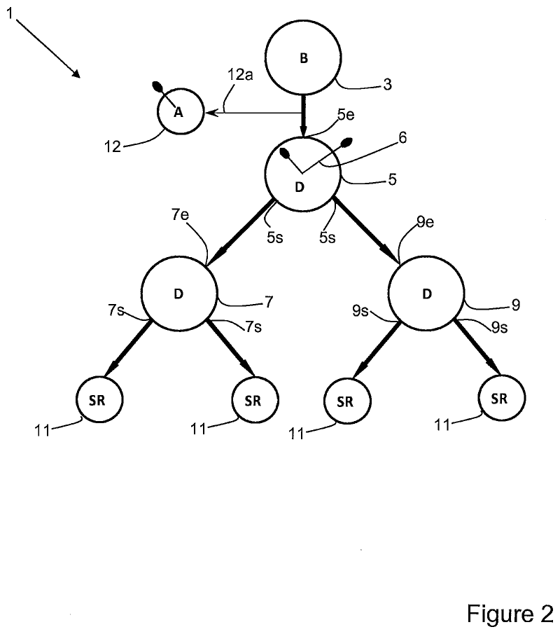

Said device 12 for displaying the seconds is thus driven by a kinematic link 12a that is branched off from the kinematic drive network 5, 7, 9, this kinematic link having a power take-off that is driven by the differential gear 5, but is not part of this network 5, 7, 9. Furthermore, neither the seconds display organ, nor a wheel that is part of the multiplicative gear train 12a, is rotationally integrated with an element forming this network 5, 7, 9. It is thus clear that no wheel situated downstream of the differential gear 5 participates in the transmission of torque to the device 12 for displaying the seconds in the illustrated embodiment. More generally, the transmission of torque and energy to the device for displaying the seconds involves exclusively wheels of the kinematic drive network 5, 7, 9 that are situated upstream of at least one of the second 7 and third 9 differential gears, as well as said multiplicative gear train 12a. The transmission of torque and energy to the regulating organs and to the device 12 for displaying the seconds thus follow paths which bifurcate at the wheel of the kinematic drive network from which the device 12 for displaying the seconds is connected. One of these branches thus leads to one or more of the regulating organs 11, the other to the device 12 for displaying the seconds. This is likewise applicable to the embodiment illustrated in FIG. 2 (see below). In the embodiment in FIG. 1, the multiplicative gear train 12a is thus branched off from the kinematic drive network 5, 7, 9 at a wheel comprised by the first differential gear 5.

As a result, a minimum of torque and energy is transmitted by this kinematic link to the device 12 for displaying the seconds, because the latter is not present in the kinematic drive network supplying energy to the regulating systems 11. The seconds display organ and the wheel associated therewith may thus be of a relatively thin construction, since the torque to which it is subjected is minimized.

The arrangement of the device 12 for displaying the seconds at the end of a multiplicative gear mechanism is common practice. However, given that a conventional movement generally does not supply sufficient torque to drive the seconds display, a barrel 3 adapted to deliver sufficiently high torque to a single regulating system 11 runs the risk of overloading and, as a result, of damaging the latter. By using four regulating systems 11, the torque supplied by the barrel 3 may be increased by a factor of four without exposing the regulating systems 11 to excessive torques or forces. As a result, and surprisingly, sufficient torque exists at the level of the first differential gear 5 to drive a seconds display 12 by means of a multiplicative gear mechanism.

In this way, the designer is no longer limited by the position of the regulating organs, or by the gears that are part of the kinematic network, in positioning the seconds display. By obtaining a power take-off from the first differential gear 5, the designer is relatively free to arrange the multiplicative gear train 12a according to his requirements, and therefore to position the seconds display at any position in the movement.

FIG. 2 depicts a second embodiment of a timepiece movement 1 according to the invention. This variant differs from that in FIG. 1 in that the device 12 for displaying the seconds is driven directly or indirectly by means of the multiplicative gear train 12a, by a wheel which is situated in the kinematic network between the drive organ 3 and the input 5e of the first differential gear 5. Alternatively, in a variant that is not illustrated here, the power take-off for the seconds display 12 may be on an element of the drive organ 3, such as on the drum of the barrel or on its arbor, for example, in the case in which the latter rotates as the barrel unwinds. In other words, the multiplicative gear train 12a is connected to the kinematic drive network 5, 7, 9 upstream of the first differential gear 5. As mentioned above, the rotating part of the barrel 3 is likewise part of the kinematic drive network and may supply sufficient torque to drive a device 12 for displaying the seconds by means of a multiplicative gear train, for the same reasons as outlined above.

In each of the embodiments described above, the indication of the seconds is determined in function of the average of the rate of the four regulating systems 11, which increases the accuracy of the display in relation to the arrangements of the prior art.

Furthermore, this configuration offers more possibilities in respect of the possible choices for the speed of rotation of the regulating systems as well as the wheels of the various differential gears 5, 7, 9, and a person skilled in the art will be aware of how to adapt the angular speeds of the various wheels together with the gear ratios for any possible construction of a timepiece movement 1 according to the invention.

1. Timepiece movement comprising:
at least one drive organ;
four regulating systems, each one being kinematically linked to said drive organ by means of a kinematic drive network arranged to transmit the energy of the drive organ to said regulating systems;
wherein said kinematic drive network comprises:
a first differential gear having one input kinematically linked to the drive organ and having two outputs;
a second and a third differential gear, each having one input kinematically linked to a respective output of the first differential gear and each having two outputs, each of these latter outputs being kinematically linked to a respective regulating system;
said movement further comprising a device for displaying the hours and the minutes arranged to be driven by the first differential gear;
wherein said movement comprises at least one device for displaying the seconds, this device being branched off from said kinematic drive network and being arranged to take power from the latter, said device for displaying the seconds comprising a seconds-indicating organ that is rotationally integrated with a wheel which is in direct or indirect meshed engagement with a wheel comprised by said kinematic drive network, said wheel being situated upstream of at least one of said second and third differential gears.

2. Movement according to claim 1, in which the device for displaying the hours and the minutes is arranged to be driven directly by an element of the first differential gear.

3. Movement according to claim 1, in which the device for displaying the seconds comprises a seconds-indicating organ arranged to be driven by an element of the first differential gear by means of a multiplicative gear train.

4. Movement according to claim 1, in which the device for displaying the seconds comprises a seconds-indicating organ arranged to be driven by an element of a barrel housing a mainspring, which serves as said drive organ, by means of a multiplicative gear train.

5. Movement according to claim 1, in which the device for displaying the seconds comprises a seconds-indicating organ arranged to be driven by an element situated between a barrel housing a mainspring, which serves as said drive organ, and said input of said first differential gear by means of a multiplicative gear train.

6. Movement according to claim 1, in which at least one of said differential gears comprises a constant force system.

7. Timepiece comprising a movement according to claim 1.
